(19) United States
(12) Patent Application Publication
(10) Pub. No.: US 2002/0004338 A1
(43) Pub. Date: Jan. 10, 2002

(54) SELECTIVELY LOCKING PLUG THERMAL ELECTRICAL CONNECTOR

(76) Inventors: AUGUST V. CORDEIRO, WARWICK, RI (US); WILLIAM W. RYMER, PROVIDENCE, RI (US)

Correspondence Address: WM. W. RYMER, 400 SOUTH MAIN STREET, PROVIDENCE, RI, 02903

(21) Appl. No.: 09/064,592

(22) Filed: Apr. 22, 1998

(51) Int. Cl. H01R 13/40

(52) U.S. Cl. 439/625

(57) ABSTRACT

A selectively releasable plug terminal connector in which an arm flexibly integral with a contactor is selectively lowered by cam surfaces carried by a housing, no portion of the arm reaching closer to the housing interior than the tip of the arm.

This invention relates to selectively lockable electrical connectors, and more particularly to plug terminal connectors in which selection is by virtue of a latch selectively engageable with a hole in a flat plug terminal responsively to positioning of a flexible arm, carrying the latch, in relation to a camming surface.

### BACKGROUND

A construction broadly as set forth above is disclosed in Gottardo et al. U.S. Pat. No. 4,976,635, “Locking Electrical Connector”, granted Dec. 11, 1990, and hereby incorporated by reference herein.

### SUMMARY

It has been discovered that a particularly useful and improved connector in the above field may be provided through a flexible arm no part of which extends further in a connector thickness, and tip, direction toward or into the connector housing than the tip of the arm.

In further embodiments, the locus of flexible arm bending may be either toward or away, relative to that tip, from the plug-receiving end of the connector housing; the housing may include one or more camming surfaces sloping either upwardly or downwardly (i.e., toward or away in a connector thickness direction from the connector contactor) as the slopes of those camming surfaces extend either toward or away from the plug-receiving housing end; the cam-(cam surface- or surfaces-)following flexible arm tip may include a cam contacting surface facing either upwardly or downwardly (as those directions are above defined), but always oppositely to any mating cam surface; the cam-following tip may be unbent relative to the adjacent portion of the flexible arm; the tip may include a reversely directed feature, the cut thickness surface of the tip riding on a cam surface; the tip may end in a T-bar with that thickness surface being on a side of the T-bar riding on a cam surface; or the tip may end in a cam-engaging flat non-thickness end portion surface engaging one or more cam surfaces.

### PREFERRED EMBODIMENT

Following is a description of preferred embodiments, in view of drawings thereof.

### DRAWINGS

FIG. 1 is an isometric view of the presently preferred embodiment.

FIG. 2 is a plan view of two thereof mounted for use delivery in reel formation.

FIG. 3 is a partially sectional view looking transversely of the vertical plane through the longitudinal centerline of said embodiment.

FIG. 3A is a view corresponding to FIG. 3 except that the housing has been moved to the right, slightly away from the contactor housing stop, to lower the latching tang so that any plug terminal (not shown) present may be removed.

FIG. 4 is a sectional view at 4-4 of FIG. 3.

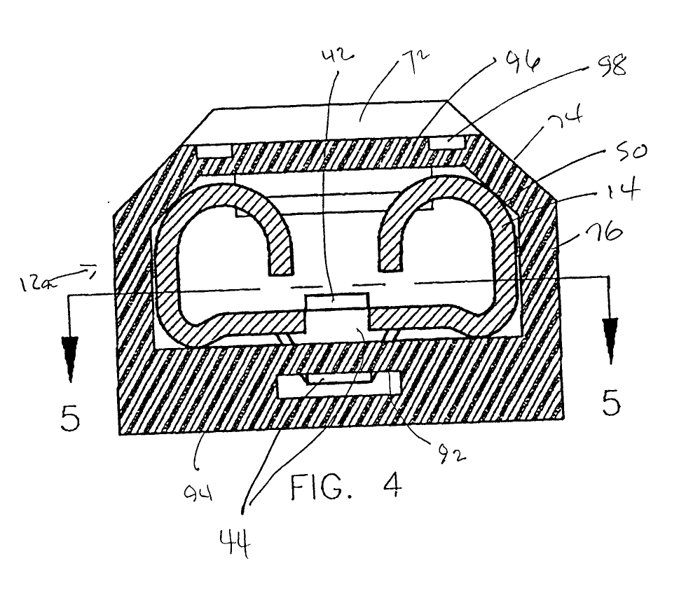

FIG. 5 is a sectional view at 5-5 of FIG. 4.

FIG. 6 is a view corresponding to FIG. 3, but of a modified embodiment.

FIG. 6A corresponds with FIG. 3A, but of said modified embodiment.

FIG. 7 is a sectional view at 7-7 of FIG. 6.

FIG. 8 is a sectional view at 8-8 of FIG. 7.

### DESCRIPTION

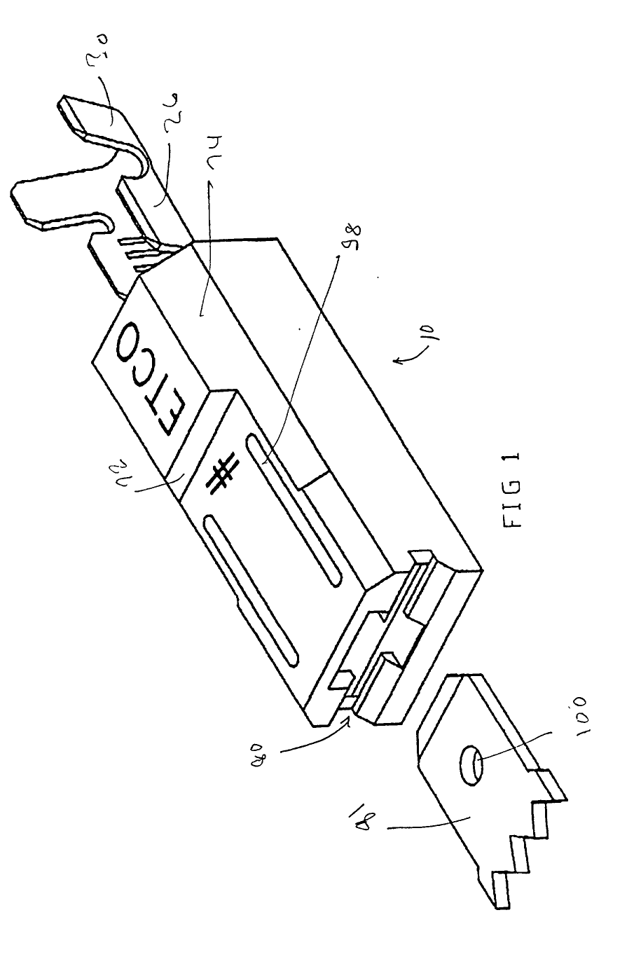

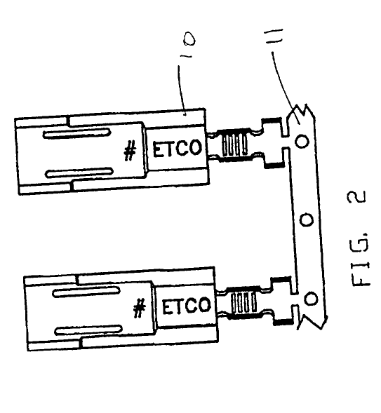

There is shown in FIG. 1 an isometric view of a connector of the invention, indicated generally at 10, and in FIG. 2 a plan view of two connectors 10 in integral through strip 11 reel formation including in fact many connectors 10 per reel.

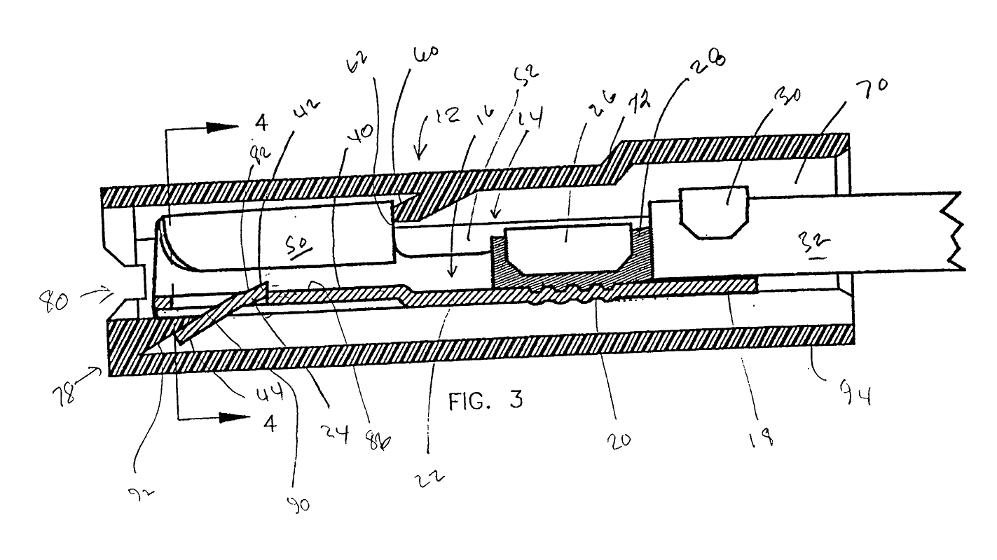

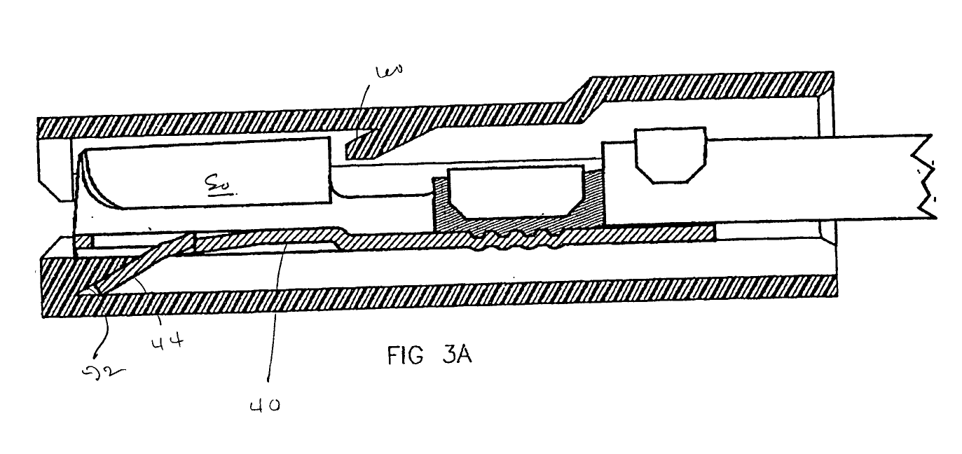

In FIG. 3 the connector 10 is shown in more detail.

An integrally injection molded (of glass-filled plasticized nylon sold by RT Material, of Winona, Minn., under the designation 205 FR) plastic housing indicated generally at 12 holds therein a contactor indicated generally at 14.

Contactor 14, conventionally is of brass, and includes a base indicated generally at 16, which includes a lower semicylindrical insulation gripping portion 18, a corrugated lower semicylindrical wire-gripping portion 20, a transition portion 22, and a latching portion 24. (As shown in FIG. 3, the portions 18 and 20 are crimped at arm 26 about wire bundle 28 and at arm 30 about insulation 32.)

Latching portion 24 includes an arm portion 40, a latch 42, and a ramp follower 44.

Curvingly above contactor portion 40 is plug receptive portion 50, adjacent which is connecting portion 52, which gradually changes from semicylindrical adjacent wire bundle 28 to flat at portion 40.

Flexible stop 60 of housing 12 is upwardly bent as contactor 14 and its crimped thereinto wire 28 and insulation 32 are moved leftwardly into housing 12, and then snaps into the locking position shown in FIG. 3, back of edge 62 of portion 50, to hold the contactor 14 positioned in housing 12.

Contactor 14 is held in opening 70 of housing 12, which includes bevels 72 and 74, side walls 76, and front wall indicated generally at 78 with horizontal opening indicated generally at 80 for flat plug terminals 81 as shown in FIG. 1.

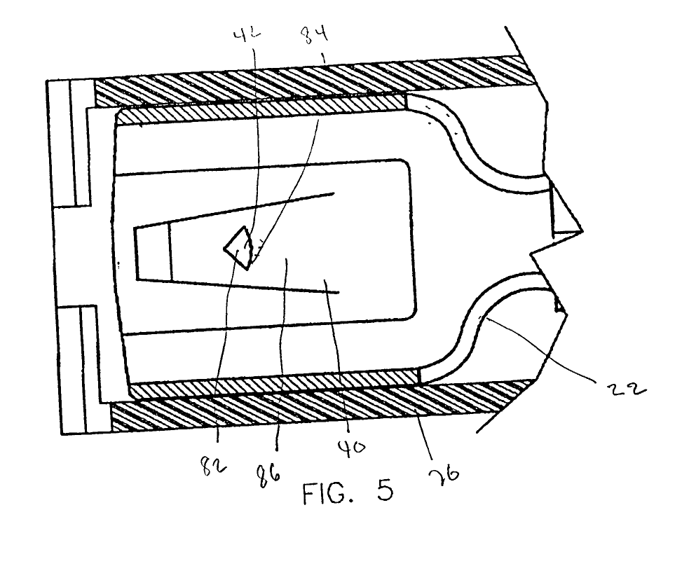

The portion 82 of the latch area is indented uncut upwardly slightly in the manner shown in FIG. 5 (not shown in FIG. 3, which shows only the upwardly displaced cutout portion away from the apex area 82 of the latch tang triangle 42). The cut-through, in the latch-producing die operation, is all around the crescent 84 of the tang, and back along the two sector radii toward their center about half each radial distance. In the die operation the metal in the zone of the arc 84 is made to flow so that instead of the arc's thickness surfacing remaining perpendicular to the sheet from which it has been cut, it is moved into perpendicularity with undistorted arm surface 86 adjacent arc 84.

Upper surface 90 of flexible arm 40 runs on cam surface 92 of housing 12. The arm lower portion, ramp follower 44, is formed so that in its stable position it is downwardly inclined, so that on assembling the contactor 14 into housing 12, the upper surface of tip 44 engages housing ramp 92.

The housing 12 also includes bottom wall 94 and top wall 96, the latter relieved by flexibility-increasing grooves 98.

In FIG. 3A is seen how when housing 12 is moved rightwardly of contactor 14 enough to produce between lock 60 and portion 50 a gap as seen, tip 44 is moved down on ramp 92, bending arm 40 as shown so that latch 42 is brought down to the level of the upper surface of portion 40, allowing any plug terminal 81 theretofore latched in to hole 100 by latch tang 42 to be easily removed.

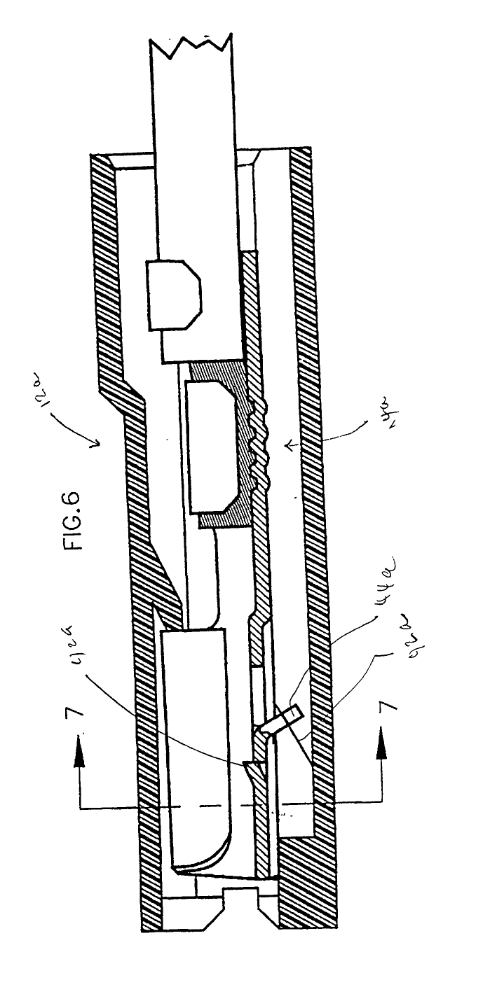

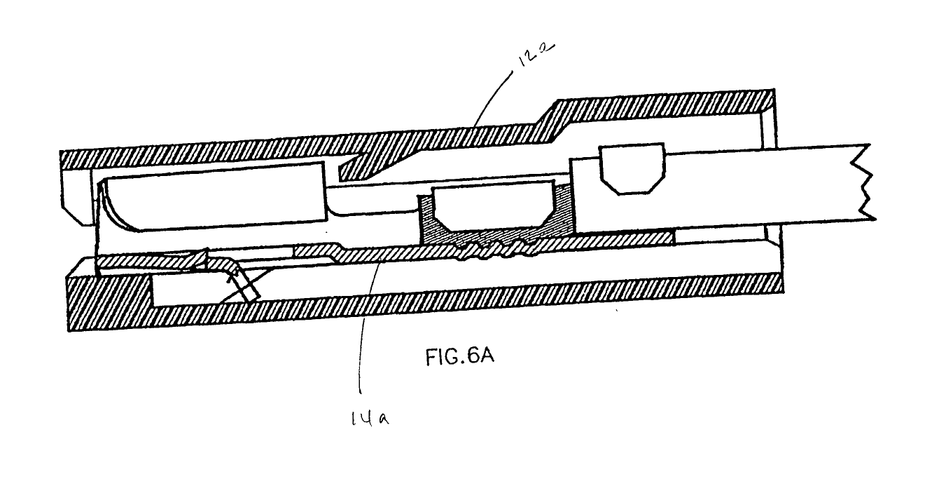

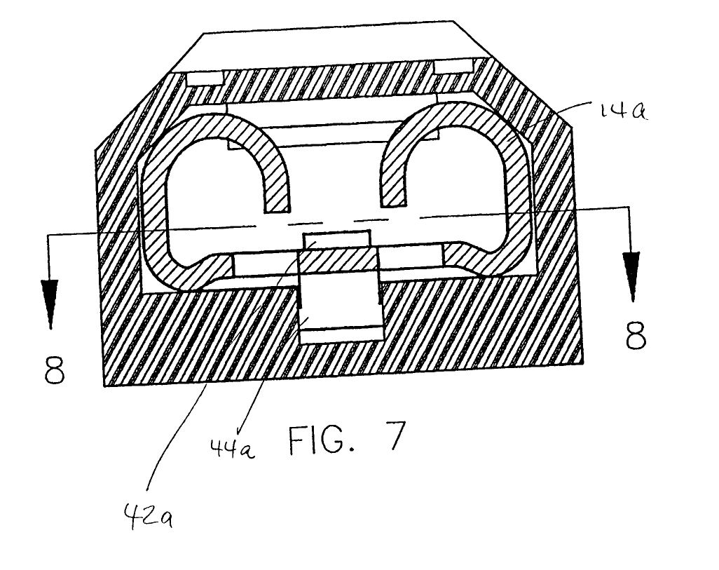

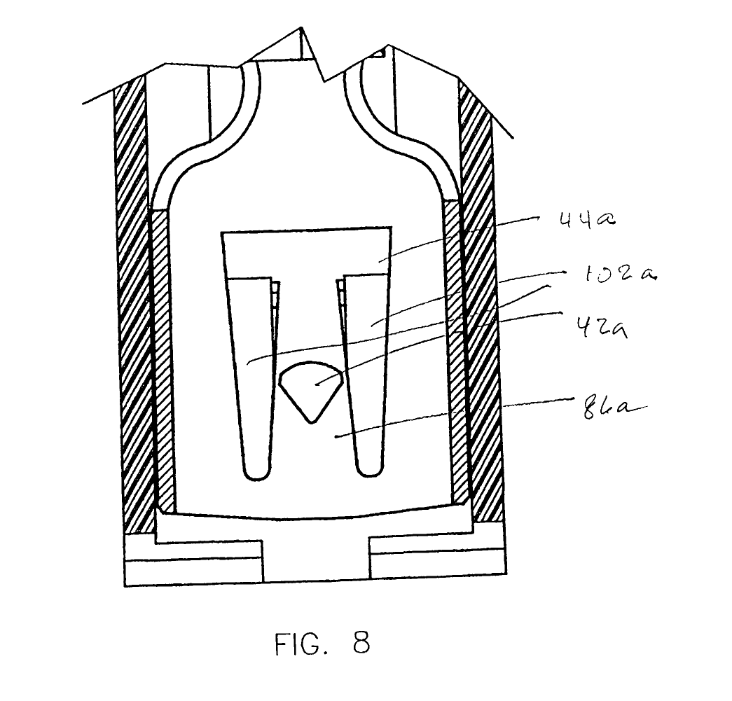

Turning to the modification of FIGS. 6 through 8, the housing indicated generally at 12a is different from that in FIG. 3 in that its integral ramps 92a are alongside, on each side, internally, of housing 12a.

The contactor, indicated generally at 14a, is different from that of FIG. 3 in that the tip 44a is a T-bar the inner thickness surface of which runs on ramps 92a, to drive down latch 42a when housing 12a is moved toward contactor 14a (FIG. 6A).

Flexible arm 86a is produced by removal from the brass thickness of portions 102a.

What is claimed is:

1. A plug terminal connector comprising
an insulating housing carrying a cam surface and
a contactor mounted in said housing and including a flexible conductive arm with a tip movable by said cam surface, said arm being nowhere nearer said housing than at said tip.

2. The connector of claim 1 in which a said cam surface is a ramp along an inner surface of said housing.

3. The connector of claim 2 in which said ramp has said cam surface facing away from said contactor and said tip engages said ramp at a crossbar end surface facing said cam surface.

4. The connector of claim 3 which includes corresponding mating cam surfaces and crossbar end surfaces on each transversely related side of said housing and said tip.

5. The connector of claim 4 in which said tip constitutes a T-shape defined by two parallel planes at an obtuse angle to the remainder of the unbent flexible arm and said end surfaces are in an arm thickness direction.

6. A plug terminal connector comprising
an insulating housing, and
an electrically conductive contactor mounted therein for small movement, selectively, relative thereto,
said housing including an opening acceptive of said plus terminal and a cam surface,
said contactor including a flexible arm carrying a latch and bendable about an axis and having a tip toward said opening from said axis and engaging said surface,
whereby said movement, selectively, moves said surface whereby said tip moves to move said latch into nonlatching position relative to said plug terminal.

7. The connector of claim 6 in which said cam surface is transversely centrally positioned on said contactor.

8. The connector of claim 7 in which said cam surface is centrally transversely positioned in said housing, an upwardly facing non-thickness surface of said tip engaging the downwardly facing surface of said cam surface.

9. The connector of claim 8 in which each said surface over its area contacting the other is planar.

10. A selectively plug-lockable and -releasable connector which comprises:
an insulating plastic housing, said housing including
a contactor element flexible latch,
contactor support means, and
a contactor flexible arm ramp;
a contactor, said contactor being of conductive metal, and including
a lower base portion supportive of an insulated semi-end and a conductive end of an insulated conductor,
said base portion including upstanding therefrom crimpable portions for holding said semi-end and said end crimpably thereagainst, and a plug-receiving portion for receiving therein a flat plug with a latch-receivable opening thicknessly therethrough, said plug-receiving portion including thereover a pair of transversely facing arcuate portions and in said base portion a said flexible arm,
said flexible arm being cut peninsularly from said base portion and flexible about a transverse area of retained integrality with said base portion,
said arm including an upwardly extending said latch and a cam surface-engaging portion,
movement of said housing away from said contactor causing said latch to move downwardly owning to movement of said flexible arm in conjunction with said cam surface,
said flexible arm having a tip lower than any other portion of said contactor and said arm.

11. The connector of claim 1 in combination with a multiplicity of other said connectors and an integral reel carrying said connectors in side by side relation.
